(19) United States
(12) Patent Application Publication
(10) Pub. No.: US 2008/0318042 A1
(43) Pub. Date: Dec. 25, 2008

(54) METHOD OF MAKING REINFORCED PVC PLASTISOL RESIN AND PRODUCTS PREPARED THEREWITH

(76) Inventor: Walter W. Kusek, Wilmington, NC (US)

Correspondence Address: John B. Hardaway, III;NEXSEN PRUET, LLC, P.O. Box 10107, Greenville, SC, 29603-0107, US

(21) Appl. No.: 12/205,321

(22) Filed: Sep. 5, 2008

Related U.S. Application Data
(63) Continuation of application No. 11/210,574, filed on Aug. 24, 2005.
Application No. 11/210,574 is a continuation-in-part of application No. 10/406,778, filed on Apr. 2, 2003, now Pat. No. 6,955,735.
Application No. 10/406,778 is a continuation-in-part of application No. 09/773,837, filed on Jan. 31, 2001, now abandoned.

(51) Int. Cl. B32B 5/02; B29C 47/00

(52) U.S. Cl. 428/378; 264/210.6

(57) ABSTRACT

A pultrusion machine for forming a laminated composite with a predetermined profile and the product obtained. The apparatus comprises at least two spools for supplying elongated reinforcements. A collator receives the elongated reinforcements and arranges the reinforcements in layered relationship to form a layered elongated bundle. A supply member wets the layered elongated bundle with plastisol to form a wetted elongated bundle. The wetted elongated bundle is transported through a pultrusion die wherein the wetted layered bundle is molded into the predetermined profile. A converting apparatus cures, or converts, the wetted layered bundle into the layered composite. A particularly preferred embodiment is an extrusion comprising a reinforcing material wherein said reinforcing material comprises a fiber reinforced plastisol.

### RELATED APPLICATIONS

This application is a continuation-in-part of pending U.S. patent application Ser. No. 10/406,778 filed Apr. 2, 2003 which is, in turn, a continuation-in-part of U.S. patent application Ser. No. 09/773,837 filed Jan. 31, 2001 which is abandoned.

### FIELD OF THE INVENTION

The present invention relates to improved composites and the production thereof. More particularly, the present invention relates to the use of plastisol in a pultrusion system and for fabricating composite structures which have improved properties.

### BACKGROUND OF THE INVENTION

Pultrusion is a well known technique for forming composite structures. In general, pultrusion involves the steps of unwinding a plurality of endless reinforcements, collating the reinforcements into a layered arrangement, wetting and/or saturating the reinforcements with a resin, and transporting the layered arrangement through a pultrusion die wherein the cross-sectional shape is formed and the resin cured or partially cured. Partially cured is referred to in the art as “B”-Stage.

Structural components in the form of beams, ribs, “J” stiffeners, “C” channels and “I” beams lend themselves well to the pultrusion process of manufacture. The strength to weight ratio of composite structural materials is many times higher than alloys of metal. This has led to extensive use in the aerospace industry. Other industries are expected to benefit as further improvements in laminated composites are made available.

Most typically the reinforcements are fabrics or fiber tows of graphite, fiberglass, Kevlar, and the like. The reinforcement is typically chosen based on strength and weight and the ability of the particular reinforcement to be wet by the resin of choice. Maximum strength is achieved, under some circumstances, when the resin completely saturates the reinforcement such that the final cross-section of the composite is a continuous polymerized resin with bands of reinforcement layered therein. If the resin fails to thoroughly wet and saturate the reinforcement the strength of the composite is compromised. In this instance the cross-section is discontinuous since there are regions which are void of polymerized resin or which have insufficient polymerized resin to achieve maximum strength. For a given choice of resins there is a limited choice of materials which can form the reinforcement. Conversely, for a given reinforcement choice the resin must be selected which will sufficiently saturate, or strongly adhere to, the reinforcement.

The properties of a resin must also be compatible with the demands of the pultrusion process. The pot life must be sufficient to allow a sufficient length of composite to be manufactured without premature curing or aging out. The resin must also be curable in a reasonable period of time. It is most preferred that the resin can be cured during the residence time in the pultrusion die to avoid relaxation or running of the resin after exiting the die. If the curing time is long the rate at which the reinforcement can be transported through the die is decreased and productivity of the manufacturing facility becomes unattractive and cost of the composite increases. Polyester resins, vinyl esters, urethanes and epoxy resins are known to be compatible with the pultrusion process.

Exemplary pultrusion methods, materials and techniques are provided in U.S. Pat. Nos. 5,989,376; 5,176,865; 5,084,222; 4,338,363; 5,556,496; 4,754,015; 4,861,621 and 4,842,667.

It has been a long standing goal to expand the composite structures which can be achieved with the pultrusion processes. In many cases, this goal has been thwarted by the limited choice of resins available. It is one object of the present invention to provide a pultrusion process with new resins which can expand the properties achievable with composite materials and the applications wherein they can be incorporated.

### SUMMARY

It is an object of the present invention to provide a method for manufacturing improved composite laminates.

It is an object of the present invention to provide a new resin system for manufacturing improved composite laminates.

It is another object of the present invention to provide a pultrusion apparatus, and method of use, which can be used to make novel composite laminates.

It is yet another object of the present invention to provide a method whereby the properties of pultruded materials can be improved to create composite laminates with improved properties.

A particular advantage of the present invention is that the method can be accomplished utilizing materials which are relatively inexpensive and readily available.

A particular advantage of the present invention is that the new resin system allows the use of materials which are relatively inexpensive and readily available.

A particular advantage is the suitability of the pultruded plastisol product for use as a reinforcement bar. Particularly, the pultruded plastisol product can be used as a reinforcement bar (rebar) in extruded products with the advantage being chemical resistance and low cost.

These, and other advantages, will be realized from the teachings herein, wherein provided is, a method of manufacturing a composite laminate comprising the steps of:

a) forming a bundle of at least two elongated reinforcements;
b) contacting the bundle with plastisol; and
c) converting or curing the plastisol to form the composite laminate.

Another embodiment of the present invention is provided in a pultrusion machine for forming a laminated composite with a predetermined profile. The apparatus comprises at least two spools for supplying elongated reinforcements. A collator receives the elongated reinforcements and arranges the reinforcements in layered relationship to form a layered elongated bundle. A supply member wets the layered elongated bundle with plastisol to form a wetted elongated bundle. The wetted elengated bundle is transported through a pultrusion die wherein the wetted layered bundle is molded into the predetermined profile. A converting apparatus cures, or converts, the wetted layered bundle into the layered composite.

A particularly preferred embodiment is an extrusion comprising a reinforcing material wherein said reinforcing material comprises a fiber reinforced plastisol.

Another embodiment is provided in a method for forming a reinforced extrusion. The method includes:

a) forming an extrusion of polyvinylchloride;
b) wrapping the extrusion with a reinforcement wherein the reinforcement is wetted with a resin with PVC and plasiticizer; and
c) fusing the resin to the extrusion.

Yet another embodiment is provided in a reinforced extrusion with an extruded polyvinylchloride core and a reinforced polyvinylchloride layer exterior to and fused to the extruded polyvinylchloride core wherein the reinforced polyvinylchloride layer has a continuous reinforcement.

### BRIEF DESCRIPTION OF THE DRAWINGS

FIG. 1 is a schematic representation of a pultrusion machine.

FIG. 2 is a schematic representation of an alternative pultrusion machine.

FIG. 3 is a schematic representation of an extrusion machine for incorporating a reinforced plastisol into a thermoplastic extrusion product.

FIG. 4 is a preferred embodiment illustrating a reinforced plastisol as a reinforcement bar in a thermoplastic extruded product.

FIG. 5 is a schematic representation of an embodiment of the present invention.

FIG. 6 is a partial cut-away view of an embodiment of the present invention.

FIG. 7 is a schematic representation of an embodiment of the present invention.

FIG. 8 is a schematic representation of an embodiment of the present invention.

### DETAILED DESCRIPTION

Pultrusion is known in the art to involve forming a laminate comprising a multiplicity of reinforcements, introducing a resin to the multiplicity of reinforcements, forming the laminate into a desired shape and curing at least a portion of the resin, also known as converting, thereby creating a laminate structure.

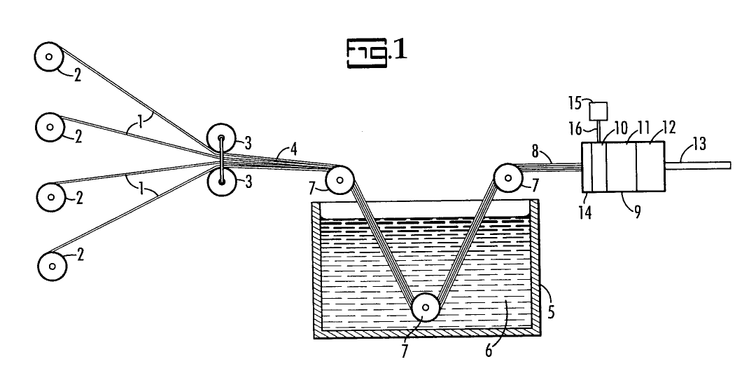

A method for pultrusion will be described in more detail with reference to FIG. 1. In FIG. 1, a multiplicity of reinforcements, 1, are fed from spools, 2. The reinforcements, 1, transit through a collator, which preferably comprises bars or guides, 3, which align the multiplicity of reinforcements and bring them into close proximity thereby forming a bundle, 4. The bundle is then passed into a resin chamber, 5, wherein the resin chamber comprises resin, 6. In a particularly preferred embodiment the resin chamber is a supply member wherein the layered bundle is wet and impregnated with plastisol. Guide bars, 7, are preferably used to guide the reinforcements into and out of the resin tank. The resin, 6, wets and/or impregnates the reinforcement. The layered arrangement of reinforcements, or bundle, exits the resin tank as a wetted elongated bundle, 8, comprising the multiplicity of reinforcements and resin. The pultrusion die, 9, comprises a forming die, 10, wherein the wetted elongated bundle, 8, is formed into a predetermined cross-sectional shape such as is common with pultrusion dies. It is also well known in the art that resin can be injected into the pultrusion die, 9, by use of an injector, 15, and associated piping, 16. In a preferred embodiment an injector acts as a supply member wherein plastisol is injected into the pultrusion die thereby incorporating plastisol into the reinforcement matrix. A curing section, 11, cures, or converts, the resin thereby forming a laminate structure, 13, in the predetermined cross-section shape. An optional section, 12, can be used to cool the laminate structure, coat additional material on the outside of the laminate structure such as paint and the like, “B”-staging, or it may be used for additional curing if necessary. An optional, but preferred stripping die, 14, may be used to attain the desired resin to reinforcement ratio. Further shaping of the pultruded product may be accomplished, if desired, in the method referred to in the art as “B”-staging wherein the resin is partially cured, further formed, and then further cured.

A particular advantage of the present invention is the ability to utilize plastisol at ambient temperature. Elimination of the need for heating the resin in the resin tank increases the efficiencies of the pultrusion system relative to prior art techniques.

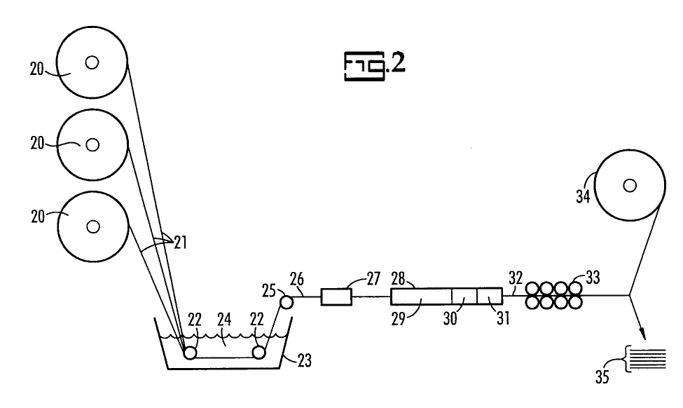

An alternative method for creating a fiber reinforced plastisol composite will be described in relation to FIG. 2. In FIG. 2 the continuous strands of reinforcement, 21, are fed from spools, 20. The reinforcement is then collated by a series of rollers, 22, and guided through a wet out pan, 23, containing plastisol, 24. A guide roller, 25, directs the layered bundle of reinforcement which is wetted with plastisol, 26, into an optional, but preferred, strip metering die, 27, wherein the ratio of plastisol to reinforcement is optimized. The wetted layered bundle of reinforcement is then directed into a heated curing die, 28, which is also referred to in the art as a heated conversion die. The heated curing die preferably comprises a pultrusion die region, 29, a curing section, 30 and an optional section which may be used to cool the laminate structure, coat additional material on the outside of the laminate such as paint and the like, “B”-staging or for additional curing if desired. The pultrusion die region, 29 and curing section, 30, may be distinct regions within the heated curing die or they may be a single region with gradients of both structural configuration and curing if so desired. The laminate structure, 32, then transits a series of pull rollers, 33, prior to transiting to a wind up roller, 34, or a finishing operation for cutting into distinct lengths, 35, for use in Guy strain rods, fishing rods, reinforcement bar and the like. In one embodiment the reinforcement wetted with plastisol may be cut to length after the strip metering die and used in subsequent molding operations. It could be considered a PVC plastisol bulk moulding compound or sheet moulding compound.

In one embodiment, the pulled reinforced material may be further coated with plastisol.

An extrusion machine for incorporating a reinforced plastisol into an extruded element is illustrated in FIG. 3. In FIG. 3 the fiber reinforced plastisol, 40, is fed from a multiplicity of spools, 41. A guide bar, 42, collates and guides the layered bundle, 43, into an optional, but preferred, surface wetting die, 44. The surface wetting die typically wets the bundle with uncured plastisol to enhance the wetting of the bundle in subsequent steps which are to be described. The surface wetting die may have curing capabilities. It is preferable that the uncured plastisol used for wetting is the same used to form the fiber reinforced plastisol but this is not a requirement. Materials other than plastisol can be used provided that they adequately wet the surface of the fiber reinforced plastisol and that they are compatible with the remainder of the process. The layered bundle, 43, is then fed into an extruder die, 45, wherein a continuous shape is made as known in the art. A standard thermoplastic is fed into the extrusion die, 45, by an extruder, 46. The extrusion product, 47, comprising a thermoplastic with fiber reinforced plastisol as a reinforcement is then obtained. An optional surface treatment section, 48, allows for additional apparati, or combinations of apparati, for subsequent treatment. Further reinforcement can be included and/or further treatment of the material can be accomplished. The surface treatment section may include a dry sizer where further curing by means of additional heat may be applied. A way winder may be included where additional wetted reinforcement can be applied to the surface of the extruded part prior to entering the dry sizer. A layered bundle, similar to 43, may be fed onto the surface or around the circumference of the extrusion product, 47, in place of, or in addition to, being fed into the extrusion die, 45, and prior to entering into the dry sizer. A coater may be included where material, such as paint, can be applied.

In one embodiment, chopped reinforced material is added to plastisol. The plastisol containing chopped reinforcement is then further used as a reinforcement material in subsequent operations.

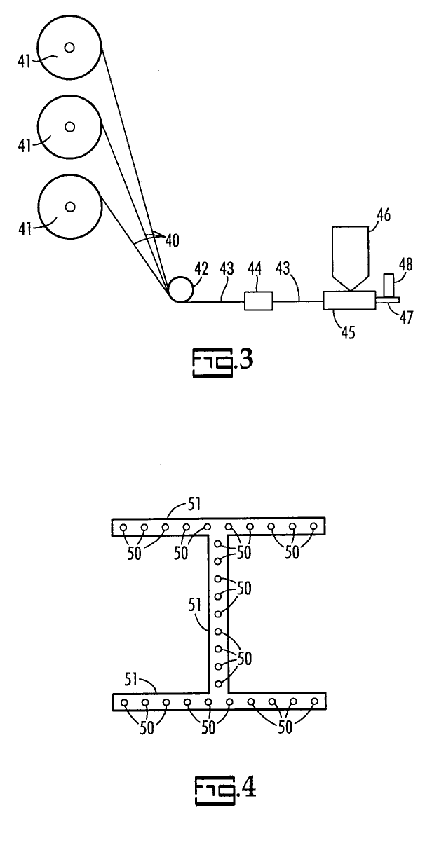

FIG. 4 illustrates an example of an inventive extrusion product wherein a fiber reinforced plastisol, 50, is the reinforcement bar of a thermoplastic, 51, in the form of, for this example an “I”-beam. Other cross-sectional shapes known in the art could be easily manufactured using the descriptions provided herein with standard extrusion techniques. The fiber reinforced plastisol may be included in an extrusion as a fully cured laminate, as a partially cured laminate or as an uncured laminate.

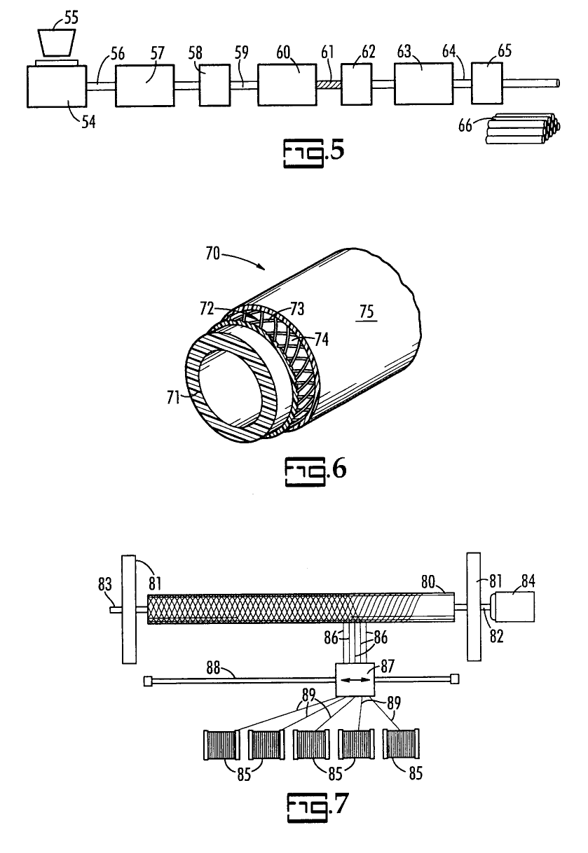

A preferred embodiment of the present invention is illustrated in FIG. 5. In FIG. 5, PVC is fed into a hopper, 55, which feeds an extruder, 54, to form an extrusion, 56. The extrusion preferably passes through a cooler, 57, to reduce the temperature. An applicator, 58, applies PVC plastisol to the surface of the extrusion to form a coated extrusion, 59. The coated extrusion passes through a winder, 60, whereby reinforcement is wrapped around the coated extrusion thereby forming a wrapped extrusion, 61. As the reinforcement wraps around the coated extrusion the reinforcement is wetted by the PVC plastisol thereby forming a PVC plastisol wetted reinforcement circumventing the extrusion. The wrapped extrusion may be further coated with an additional coating of PVC plastisol at an optional extruder, 62. The PVC plastisol is then fused by heat in an oven, 63, thereby forming a reinforced extrusion, 64. The oven preferably has an entrance die whereby the surface of the PVC plastisol is shaped to conform to the external shape of the extrusion. The reinforced extrusion is then cut to length by a cut-off tool, 65, and collected for distribution in a stack, 66.

The cross-sectional shape and size of the extrusion is defined by the extrusion die and is not particularly limited herein. The extrusion may be solid or it may form a pipe with a cross-sectional shape of round, oblong, trigonal, rectangular or polygonal. A round extrusion with a central void, as in a pipe, is most preferred due to the large demand for such items.

The winder is either a single rotating winder or a counter rotating winder as known in the art. Instead of a winder an overlayer may be used wherein at least some of the wetted reinforcement is applied to one surface without circumventing the extrusion.

An embodiment of the present invention is illustrated in partial cut-away view in FIG. 6. In FIG. 6, the reinforced extrusion, 70, comprises a PVC core, 71. The PVC core may be solid or hollow with any cross-sectional shape which can be extruded. Circumventing the PVC core is a reinforced PVC plastisol layer, 72, comprising reinforcement, 73, and plastisol, 74. The PVC plastisol layer is also referred to herein as a laminate. The PVC plastisol is fused to the PVC core. Circumventing the PVC plastisol layer is an optional, but preferred, PVC plastisol surface coat, 75. The PVC plastisol surface coat insures complete wetting of the reinforcement and provides a smooth surface. The PVC plastisol surface coat is fused to the reinforced PVC plastisol layer.

The extrusion, plastisol and optional surface coat each preferably comprise PVC thereby allowing the layers to fuse during curing. The combination of a wetted reinforcement, and fused layers, provides a strength previously unavailable at a given layer thicknesses of PVC.

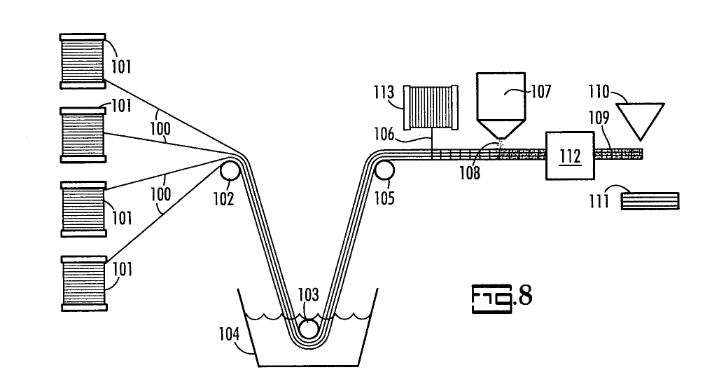

Yet another embodiment is illustrated in FIG. 7. In FIG. 7, an extrusion, 80, is mounted in a mandrel, 81, comprising a drive arbor, 82, and an idle arbor, 83. Alternatively, a shaft may be employed instead of the arbors. The drive arbor is rotated by a drive mechanism, 84, such as a motor. As the extrusion is rotated PVC plastisol wetted reinforcement, 86, is drawn from a PVC plastisol bath, 87, which is supplied by spools, 85, of dry reinforcement, 89. The PVC plastisol bath transits along a trolley, 88, thereby wrapping the extrusion in a PVC plastisol wetted reinforcement. It is preferable that the bath transits from one end of the extrusion to the other and back to provide a double helical layer of reinforcement. In another embodiment the bath is fixed and guide rollers transit along a trolley. The extrusion comprising the plastisol wetted reinforcement wrapped there around is then cured resulting in a reinforced extrusion.

Yet another embodiment is illustrated in FIG. 8. In FIG. 8 reinforcement, 100, is fed from rolls, 101, and directed by guide rollers, 102, 103 and 105, through a pultrusion bath, 104, to form wetted collated strands. A wrapping strand, 106, supplied by a roll, 113, is wrapped around the wetted collated strands. Surface treatment, 108, such as silica, is applied by a hopper, 107. The surface treatment is preferably an embedded particle to increase surface area and to increase pullout resistance when used as a reinforcement. The material is then cured at 112, to form the final product, 109, which is then cut at 110 to form individual elements, 111. These materials are particularly well suited for use in any application where metal reinforcement bar, referred to as rebar, is typically used.

Plastisol is widely known to be a blend of high molecular weight polymeric resin, typically polyvinylchloride (PVC), in a non-volatile nonaqueous plasticizer. It is also known in the art that adjuvants such as fillers, stabilizers, adhesion promoters, and surfactants can be added to plastisol. It is most preferable that the plastisol content of the reinforced plastisol be from about 20 to about 80 weight percent based on the total weight of the cured laminate material. More preferably, the plastisol content of the laminate is from about 30 to about 70 weight percent based on the total weight of the cured laminate material. Most preferably, the plastisol content of the laminate is from about 30 to about 60 weight percent based on the total weight of the cured laminate material.

Resins which are useful in the present invention include homopolymers and copolymers of polyvinylchloride. A homopolymer of vinylchloride is most preferred. Specific copolymers of vinylchloride include polymerized monomers of acrylate, specifically methacrylate; acrylonitrile, styrene, phenyleneoxide, acrylic acid, maleic anhydride, vinyl alcohol and vinyl acetate.

Plasticizers are preferably compounds with low volatility and which have the ability to disperse polymeric resin particles. It is also preferable that the plasticizers facilitate adherence of the polymeric resin to the fibers. Typical plasticizers include, normal and branched chain alcoholic esters and glycol esters of various mono-, di- and tri-basic acids, for example esters of phthalic, adipic, sebacic, azelaic, citric, trimellitic (and anhydride) and phosphoric acids; chlorohydrocarbons; esters of long chain alcohols; liquid polyesters; and epoxidized natural oils, such as linseed and soya oils. Representative phthalate plasticizers include: di-2-ethylhexyl phthalate, n-C6-C8-C10 phthalate, n-C7-C9-C11 phthalate, n-octyl-n-decyl phthalate, ditridecyl phthalate, diisonyl phthalate, diisooctyl phthalate, diisodecyl phthalate, butylbenzylphthalate, dihexyl phthalate, butyl ocytyl phthlate, dicapryl phthalate, di-2-ethylhexyl isophthalate, alkyl benzene phthalates, dimethyl phthalate, dibutyl phthalate, diisobutyl phthalate, butyl isodecyl phthalate, butyl iso-hexyl phthalate, diisononyl phthalate, dioctyl phthalate, hexyl octyl decyl phthalate, didecyl phthalate diisodecyl phthalate, diundecyl phthalate, butyl-ethylhexyl phthalate, butylbenzyl phthalate, octylbenzyl phthalate, dicyclohexyl phthalate, diphenyl phthalate, alkylaryl phthalates, and 2-ethylhexylisodecyl phthalate. Additional plasticizers include: abietic derivatives are suitable such as: hydroabietyl alcohol, methyl abietate and hydrogenated methyl abietate; acetic acid derivatives such as cumylphenylacetate; adipic acid derivatives such as benzyloctyl adipate, dibutyl adipate, diisobutyl adipate, di-octyladipate, di-2-ethylhexyl adipate, diisononyl adipate, diisooctyl adipate, dinonyl adipate, C₇₋₉ linear adipate, dicapryl adipate, octyl decyl adipate (such as n-octyl, n-decyl adipate), straight chain alcohol adipate, didecyl adipate, diisodecyl adipate, dibutoxyethyl adipate, high molecular weight adipate, polypropylene adipate, modified polypropylene adipate; azelaic acid derivatives such as dicyclohexyl azelate, di-2-ethylhexyl azelate, di-n-hexyl azelate, diisooctyl azelate and diisodecyl adipate; benzoic acid derivatives such as diethylene glycol dibenzoate, dipropylene glycol dibenzoate, diethylene glycol benzoate and dipropylene glycol benzoate blend, neopentyl glycol dibenzoate, glyceryl tribenzoate, trimethylolethatane tribenzoate, pentaerythritol tribenzoate, cumylphenylbenzoate; polyphenyl derivatives such as hydrogenated terphenyl; citric acid derivatives, such as triethyl citrate, tri-n-butyl citrate, acetyl triethyl citrate, acetyl tri-n-butyl citrate, acetal tributyl citrate; epoxy derivatives such as butyl epoxy stearate, alkyl epoxy stearate, epoxidized butyl ester, epoxidized octyl tallage, epoxidized triglyceride, epoxidized soybean oil, epoxidized sunflower oil, epoxidized linseed oil, epoxidized tallate ester, 2-ethylhexyl-epoxy tallate, octyl epoxy stearate; ether derivatives such as cumylphenyl benzyl ether; formal derivatives such as butyl carbitol formal; fumaric acid derivatives such as dibutyl fumarate, diisooctyl fumarate, dioctyl fumarate; glutaric acid derivatives such as mixed dialkyl glutarates and dicumylphenyl glutarate; glycol derivatives such as diethylene glycol dipelargonate, triethylene glycol dipelargonate, triethylene glycol di-(2-ethylbutyrate), triethylene glycol di-caprylate-caprate, triethylene glycol di-(2-ethylhexoate), triethylene glycol dicaprylate, tetraethylene glycol dicaprylate, polyethylene glycol di-(2-ethylhexoate), butyl phthalyl butyl glycolate, triglycolester of vegetable oil fatty acid, triethylene glycol ester of fatty acid; linear dibasic acid derivatives such as mixed dibasic ester; petroleum derivatives such as aromatic hydrocarbons; isobutyric acid derivatives such as 2,2,4-trimethyl-,1,3-pentanediol diisobutyrate; isophthalic acid derivatives such as di(2-ethylhexyl)isophthalate, diisooctyl isophthalate, dioctylisophthalate; lauric acid derivatives such as butyllaurate, 1,2-propylene glycol monolaurate, ethylene glycol monoethyl ether laurate, ethylene glycol monobutyl ether laurate, glycerol monolaurate, polyethylene glycol-400-dilaurate; mellitic acid derivatives such as n-octyl, n-decyl trimellitate, tri-n-octyl-n-decyl trimellitate, triisononyl trimellitate, triisooctyl trimellitate, tricapryltrimellitate, diisooctyl monoisodecyl trimellitate, triisodecyl trimellitate, tri(C₇₋₉ alkyl) trimellitate, tri-2-ethylhexyl trimellitate; nitrile derivatives such as fatty acid nitrile; oleic acid derivatives such as butyl oleate, 1,2-propylene glycol mono oleate, ethylene glycol monobutyl ether oleate, tetrahydrofurfuryl oleate, glycerlyl monoleate; paraffin derivatives such as chlorinated paraffins, diethylene glycol dipelargonate, triethylene glycol dipelargonate, 2-butoxyethyl dipelargonate; phenoxy plasticizers such as acetyl paracumyl phenol; phosphoric acid derivatives such as tri-(2-ethylhexyl) phosphate, tributoxyethyl phosphate, triphenyl phosphate, cresyl diphenyl phosphate, tricresyl phosphate, tri-isopropylphenyl phosphate, alkyl aryl phosphates, diphenyl-xylenyl phosphate, phenyl isopropylphenyl phosphate 2-ethylhexyl diphenyl phosphate, and decyl diphenyl phosphate; ricinoleic acid derivatives such as methylacetyl riconoleate, n-butyl acetyl ricinoleate, glyceryl triacetyl ricinoleate; sebacic acid derivatives such as dimethyl sebacate, dibutyl sebacate and dibutoxyethyl sebacatel; stearic acid derivatives such as glyceryl tri-acetoxy stearate, butyl acetoxy stearate, methylpentachlorostearate and methoxyethyl acetoxy stearate; sucrose derivatives such as sucrose benzoate; sulfonic acid derivatives such as alkyl-sulfonic esters of phenol; tall oil derivatives such as methylester of tall oil and isooctyl ester of tall oil; and terephthalic acid derivatives such as dioctyl terephthalate.

Particularly preferred plasticizing resins include: di-2-ethylhexyl phthalate, n-C6-C8-C10 phthalate, n-C7-C9-C11 phthalate, diisooctyl phthalate, diisodecyl phthalate, butylbenzyl phthalate, dihexyl phthalate, diisononyl phthalate, di-2-ethylhexyl adipate, diisononyl adipate, diisodecyl adipate, di-2-ethylhexyl azelate, dipropylene glycol dibenzoate, epoxidized soybean oil and epoxidized linseed oil.

The term “reinforcement”, as used herein, refers to reinforcing fibers including filaments, yarn, roving, mats, felt, ribbon, tape, fabric and the like in continuous form. The reinforcement is usually aligned parallel to the flow of material and includes stitched or braided fibers. Any combination of reinforcement materials can generally be used as long as they can be sufficiently wet by the resin to form a material with adequate properties. The number and orientation of the reinforcements used in a laminate will vary according to the specific cross-sectional shape desired, strength requirements, weight requirements and other considerations as known in the art. It is most preferable that the fiber content of the laminate be from about 20 to about 80 weight percent based on the total weight of the cured laminate material. More preferable, is a laminate with a fiber content of from about 30 to about 70 weight percent based on the total weight of the cured laminate material. Most preferably, the laminate has a fiber content of from about 40 to about 70 weight percent based on the total weight of the cured laminate material.

The reinforcement can be any conventional material known to the art for reinforcing laminates included metal fibers; glass fibers, such as E-glass, A-glass, C-glass, D-glass, AR-glass, R-glass, S1-glass, S2-glass; basalt fiber marketed by Kamenny Vek of Russia, carbon fibers such as graphite; boron fibers; ceramic fibers such as alumina or silica; aramid fibers such as Kevlar® marketed by E.I. duPont de Nemours, Wilmington, Del.; synthetic organic fibers such as polyamide, polyethylene, paraphenylene, terephthalamide, polyethylene terephthalate and polyphenylene sulphide; and various other natural or synthetic inorganic or organic fibrous materials known to be useful for reinforcing thermosetting polymeric compositions, such as cellulose, asbestos, cotton and the like.

Particularly preferred reinforcements include: E-glass, A-glass, C-glass, D-glass, AR-glass, R-glass, S1-glass, S2-glass, basalt fiber, graphite; boron, and aramid.

Curing may be accomplished by a variety of techniques known in the art including, thermal, photoactivation, e-beam or other radiation type curing, and others. In the present invention thermal curing or conversion is most preferred and a particularly preferred embodiment is curing at a temperature of 250-400° F.

### EXAMPLES

A reinforcement of PPG-712-225 Glass and was introduced into a pultrusion die at 1-20 ft/min. A PVC plastisol which is a polyvinyl chloride dispersion available from Rutland Plastic Technologies, Inc., Pineville, N.C., as product code RDP-3267 was injected into the pultrusion die at a rate of 100 ml/min. The resulting laminate was cured at 340° F. for one minute. A comparative example was prepared using polyester as a resin. The resulting laminate was tested and found to have the properties shown in Table 1.

TABLE 1

| | Inventive | Comparative |
|---|---|---|
| Tensile Strength (psi) | >86,000 | 120,000 |
| Flexural Strength (psi) | >75,500 | 100,000 |
| Flexural Modulus (×10⁶) | >3 | 4 |
| Elongation (%) | 3.4 | 2.8 |

The inventive sample has properties which are immanently suitable for use as a pultruded device or as a reinforcement bar in an extruded element. The inventive material is especially suitable as a reinforcement due to adequate Theological properties, excellent chemical resistance and low cost.

The inventive PVC pultrusion, when added to a standard PVC or CPVC extrusion would enhance the applications of the extruded product by increasing the load bearing capability due to the intimate bonding between the pultruded reinforcement and the extrusion matrix.

A particular application is use in harsh chemical environments such as in salt water applications, tank and pipe design, and as a concrete reinforcement. The pultruded PVC is an excellent replacement for metal reinforcement bars since the pultruded PVC does not rust or corrode.

A schedule 40 PVC pipe has a rated pressure of about 220 PSI at ambient temperature. If a PVC pipe were extruded at about 0.090 inches (2.28 mm) less than standard wall thickness and the difference in thickness made up with an 0.05 inch (1.27 mm) plastisol reinforcement wrap and an 0.04 inch (1.01 mm) plastisol over layer the burst strength and rating would be more than doubled.

A typical thermoset pultruded mat/roving product was prepared as a control. Three inventive samples were then prepared in accordance with the inventive process. In IS-1 the mat/roving was replaced with a roving wetted with plastisol. In IS-2 the plastisol resin incorporated calcium carbonate as a filler and in IS-3 a plastisol with about 15 wt % mat was used. For each sample the tensile strength (Ksi) was measured in accordance with ASTM D638; the linear Izod impact strength (Ft-lb/in) was determined in accordance with ASTM D256; the water absorption (% wt.) was determined in accordance with ATM D570 and the dielectric strength (Kv/in.) was determined in accordance with ASTM D149. The results were normalized and are reported in Table 2.

TABLE 2

| | Normalized | | | |
|---|---|---|---|---|
| Property | Control | IS 1 | IS 2 | IS 3 |
| Tensile Strength | 1 | 3.7 | 2.8 | 2.8 |
| Izod Impact Strength | 1 | 2.5 | 2.4 | 2.4 |
| water absorption | 1 | .3 | .3 | .3 |
| dielectric strength | 1 | 2.4 | 2.4 | 2.4 |

The results clearly indicate a substantial improvement over the existing art particularly with regards to dielectric strength, Izod impact strength, tensile strength and water absorption.

The invention has been described with particular reference to the preferred embodiments without limit thereto. One of skill in the art would realize additional embodiments which are within the scope of the invention which is more precisely set forth in the claims appended hereto.

1-31. (canceled)

32. A method of manufacturing comprising:
feeding fiber reinforced plastisol into an extrusion die;
feeding a thermoplastic into said extrusion die; and
extruding a thermoplastic material and at least one said fiber reinforced plastisol to produce an extruded element comprising said fiber reinforced plastisol.

33. The method of manufacturing of claim 32 further comprising curing said plastisol.

34. The method of manufacturing of claim 33 wherein said curing is prior to said feeding a thermoplastic into said extrusion die.

35. The method of manufacturing of claim 32 wherein said fiber reinforced plastisol is fed from a spool.

36. The method of manufacturing of claim 32 comprising feeding a fiber reinforced cured plastisol into said extrusion die.

37. The method of manufacturing of claim 32 comprising feeding fiber reinforced plastisol in a layered bundle into said extrusion die.

38. The method of manufacturing of claim 32 wherein said feeding a fiber reinforced plastisol and said feeding a thermoplastic into said extrusion die are simultaneous.

39. An extruded product made by the process of claim 32.

40. The method of manufacturing of claim 32 wherein said fiber reinforced plastisol is reinforced with a material selected from a group consisting of metal fibers, glass fibers, carbon fibers, ceramic fibers, aramid fibers, synthetic organic fibers, synthetic inorganic fibers, natural inorganic fibers and natural organic fibrous material.

41. The method of manufacturing of claim 32 wherein said fiber reinforced plastisol is reinforced with a material selected from a group consisting of E-glass, A-glass, C-glass, D-glass, AR-glass, R-glass, S1-glass, S2-glass, graphite fibers, boron fibers, alumina fibers, silica fibers, aramid fibers, polyamide fibers, polyethylene fibers, paraphenylene fibers, terephthalamide fibers, polyethylene terephthalate fibers, polyphenylene sulphide fibers, cellulose fibers, asbestos fibers and cotton fibers.

42. The method of manufacturing of claim 32 wherein said plastisol comprises polyvinylchloride and a plasticizer.

43. The method of manufacturing of claim 42 wherein said polyvinylchloride is a copolymer formed from vinyl chloride monomer and at least one monomer chosen from a group consisting of methacrylate, acrylonitrile, styrene, phenyleneoxide, acrylic acid, maleic anhydride, vinyl alcohol and vinyl acetate.

44. The method of manufacturing of claim 32 wherein said fiber reinforced plastisol is a pultruded fiber reinforced plastisol.

45. A structural composite laminate made by a method comprising:
collating at least two elongated reinforcements;
wetting the collated reinforcements with a plastisol by pulling said collated reinforcements through a bath of said plastisol wherein said plastisol is in surface contact with each of said at least two elongated reinforcements;
pulling the plastisol-wetted collated reinforcements through a forming die; and
curing the plastisol component of said plastisol-wetted collated reinforcements in a die to produce a structural composite laminate and fixing dimensions of said composite structural laminate in said die.

46. The structural composite laminate claim 45 wherein said fiber is selected from a group consisting of metal fibers, glass fibers, carbon fibers, ceramic fibers, aramid fibers, synthetic organic fibers, synthetic inorganic fibers, natural inorganic fibers and natural organic fibrous material.

47. The structural composite laminate of claim 45 wherein said plastisol comprises polyvinylchloride and a plasticizer.

48. The structural composite laminate of claim 47 wherein said polyvinylchloride is a copolymer formed from vinyl chloride monomer an at least one monomer chosen from a group consisting of methacrylate, acrylonitrile, styrene, phenyleneoxide, acrylic acid, maleic anhydride, vinyl alcohol and vinyl acetate.

49. A method of making an extruded element from a structural composite laminate of claim 45 further comprising:
extruding a thermoplastic material and a plurality of said structural composite laminate to produce an extruded element comprising said plurality of said reinforced shaped composites.

50. An extruded element made according to the method of claim 49.

51. An extruded element made a method comprising:
collating at least two elongated reinforcements;
wetting the collated reinforcements with a plastisol by pulling said collated reinforcements through a bath of said plastisol whereby said plastisol is in surface contact with each of said at least two elongated reinforcements;
pulling the plastisol-wetted collated reinforcements through a forming die;
curing the plastisol component of said plastisol-wetted collated reinforcements in a die to produce a structural composite laminate and fixing dimensions of said composite structural laminate in said die; and
extruding a thermoplastic material and a plurality of said structural composite laminate to produce an extruded element comprising said plurality of reinforced shaped composites.
